(19) United States
(12) Patent Application Publication
(10) Pub. No.: US 2013/0192306 A1
(43) Pub. Date: Aug. 1, 2013

(54) METHOD FOR PRODUCING POROUS GLASS

(71) Applicants: Akira Sugiyama, Yokohama-shi (JP); Zuyi Zhang, Yokohama-shi (JP); Yoshinori Kotani, Yokohama-shi (JP); Kenji Takashima, Tokyo (JP)

(72) Inventors: Akira Sugiyama, Yokohama-shi (JP); Zuyi Zhang, Yokohama-shi (JP); Yoshinori Kotani, Yokohama-shi (JP); Kenji Takashima, Tokyo (JP)

(73) Assignee: CANON KABUSHIKI KAISHA, Tokyo (JP)

(21) Appl. No.: 13/876,692

(22) PCT Filed: Sep. 16, 2011
(86) PCT No.: PCT/JP2011/005248

§ 371 Date: Mar. 28, 2013

(30) Foreign Application Priority Data
Sep. 30, 2010 (JP) 2010-220570
Sep. 5, 2011 (JP) 2011-192812

(51) Int. Cl. C03C 11/00

(52) U.S. Cl. CPC C03C 11/005
USPC 65/31

(57) ABSTRACT

There is provided a method for producing a porous glass having high porosity and nanosized pores even at a deeper portion in the glass.

A method for producing a porous glass includes the steps of preparing a glass body containing boron, subjecting the glass body to heat treatment for phase separation, and bringing the phase-separated glass body into contact with a boron-containing solution having a boron concentration of 5 to 140 ppm.

### TECHNICAL FIELD

The present invention relates to a method for producing a porous glass.

### BACKGROUND ART

Porous glass produced utilizing the phase-separation phenomenon of glass has a unique, uniformly controlled porous structure. The pore size can be adjusted within a certain range. Porous glass should be industrially used for, for example, adsorbents, microcarriers, separation membranes, and optical materials, taking advantage of such excellent characteristics.

For these industrial applications, a porous structure having extra-fine nanosized pores is often required. Even in the case of such nanosized pores, an excellent porous structure must be provided.

A porous glass obtained by the use of the phase-separation phenomenon is produced as follows.

A phase-separable glass is phase-separated by heat treatment into a phase (soluble phase) having a higher boron content than that of the phase-separable glass and a phase (insoluble phase) having a lower boron content than that of the phase-separable glass, the phases being arranged in the form of a network.

Then the soluble phase is selectively etched with, for example, an acid solution to form a porous structure, thereby providing a porous glass including a silica skeleton with a three-dimensional network structure (for example, see NPL 1).

Hitherto, acids, such as hydrochloric acid and nitric acid, have been used as etching solutions (for example, see PTLs 1 and 2). In the case of using such an acid, however, a phenomenon is observed in which gel-like silica is deposited in pores at the inside of a glass (for example, see NPL 2). In particular, finer pores are more likely to cause the phenomenon.

Etching conditions and the composition of an etching solution may play important roles in etching. There is almost no study that focuses attention on the composition of an etching solution. Under present circumstances, a porosity level that allows the performance of porous glass to be sufficiently provided is not achieved.

As a technique for selective etching of two different glasses, a study that focuses attention on an etching solution has been conducted. PTL 3 discloses a technique for selective etching of two different glasses, the technique aiming to inhibit the etching of a non-etching phase by the use of an etching solution containing a large amount of a component contained in the non-etching phase, thereby resulting in high etching selectivity.

However, in the case of the selective etching of a glass utilizing a phase-separation phenomenon, a non-etching phase is almost composed of silica, and a soluble phase also contains silica. So, the technique for using an etching solution containing a component contained in a non-etching phase cannot be employed for the etching of a phase-separated glass.

The phase-separation phenomenon is a phenomenon that forms a three-dimensional structure. It is thus difficult to selectively etch not only a surface of a glass but also the inside of the glass, compared with the case of typical etching of a glass. Furthermore, it is extremely difficult to selectively etch the glass from a surface to the inside of the glass to form a porous structure having extra-fine nanosized pores by an etching technique in the related art.

So, a porous glass does not sufficiently exert the performance. There is a strong need for an etching technique to produce a porous glass having a porous structure with extra-fine nanosized pores without depositing gel-like silica.

### CITATION LIST

### Patent Literature

PTL 1: Japanese Patent Laid-Open No. 2002-56520

PTL 2: Japanese Patent Laid-Open No. 2006-193341

PTL 3: Japanese Patent Laid-Open No. 08-175847

### Non Patent Literature

NPL 1: M. J. Minot, J. Opt. Soc. Am., Vol. 66, No. 6, 1976.

NPL 2: Tanaka, Yazawa, Eguchi, Yogyo-Kyokai-Shi (Journal of the Ceramic Society of Japan), 91(1056), p. 384

### SUMMARY OF INVENTION

### Technical Problem

As described above, there is a strong need for an etching technique for selectively removing a soluble phase even located at a deeper portion in a glass, the soluble phase having a nanosized three-dimensional network structure that is formed by subjecting the glass to the heat treatment for phase separation.

The present invention has been made in view of the background art. Aspects of the present invention provide a method for producing a porous glass having high porosity and nanosized pores even at a deeper portion in the glass.

### Solution to Problem

To overcome the foregoing problems, a method for producing a porous glass includes the steps of preparing a glass body containing boron, subjecting the glass body to the heat treatment for phase separation, and bringing the phase-separated glass body into contact with a boron-containing solution having a boron concentration of 5 to 140 ppm.

### Advantageous Effects of Invention

Aspects of the present invention provide a method for producing a porous glass having high porosity and nanosized pores even at a deeper portion in the glass.

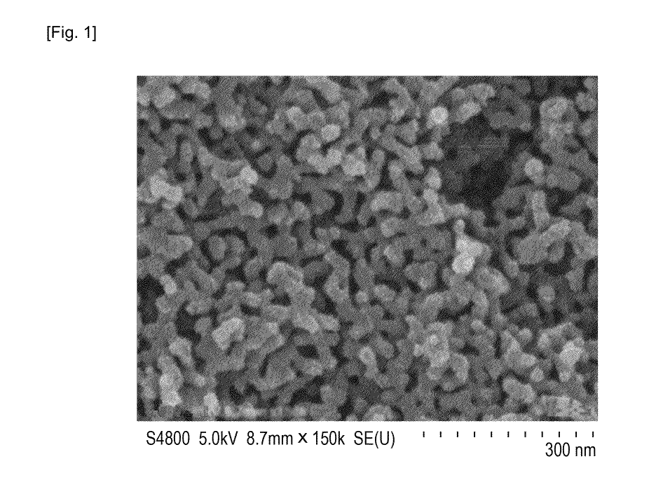

### BRIEF DESCRIPTION OF DRAWINGS

[FIG. 1] FIG. 1 is an electron micrograph of a cross section of a porous glass produced in EXAMPLE 1 of the present invention.

### DESCRIPTION OF EMBODIMENTS

A method for producing a porous glass according to aspects of the present invention includes the steps of preparing a glass body containing boron, subjecting the glass body to phase separation by heating, and bringing the phase-separated glass body into contact with a boron-containing solution having a boron concentration of 5 to 140 ppm.

Aspects of the present invention provide a method for producing a porous glass, the method including selectively etching a glass phase subjected to phase separation and allowing the etching to proceed to a deeper portion of the glass, whereby the porous glass has high porosity and nanosized pores even at a deeper portion in the glass.

Embodiments of the present invention will be described in detail below by taking a method for producing a porous glass using a common phase-separated glass as an example.

According to aspects of the present invention, it is essential that a glass body which serves as a matrix of a porous glass and which can be subjected to phase separation (hereinafter, also referred to as a “phase-separable glass body”) and a glass body that has been subjected to phase separation (hereinafter, also referred to as a “phase-separated glass body”) by heating a phase-separable glass each contain a boron component.

The term “phase separation” indicates that, for example, in the case of using a borosilicate-based glass having a composition of silicon oxide-boron oxide-alkali metal oxide as a phase-separable glass, the inside of the glass is separated into a phase in which the proportion of alkali metal oxide-boron oxide is higher than that before phase separation and a phase in which the proportion of alkali metal oxide-boron oxide is lower than that before phase separation, each of the phases having a structure with a size of several nanometers.

Examples of a material for the phase-separable glass according to aspects of the present invention include, but are not particularly limited to, silicon oxide-based phase-separable glass I (glass body composition: silicon oxide-boron oxide-alkali metal oxide), silicon oxide-based phase-separable glass II (glass body composition: silicon oxide-boron oxide-alkali metal oxide-(alkaline-earth metal oxide, zinc oxide, aluminum oxide, zirconium oxide)), and titanium oxide-based phase-separable glass (glass body composition: silicon oxide-boron oxide-calcium oxide-magnesium oxide-aluminum oxide-titanium oxide).

Among these glasses, a borosilicate-based glass having a composition of silicon oxide-boron oxide-alkali metal oxide can be used as the phase-separable glass.

The borosilicate-based glass preferably has a silicon oxide content of 55% by weight or more and particularly preferably 60% by weight or more. A silicon oxide content of 60% by weight or more has a tendency to lead to an increase in the skeletal strength of a porous glass and is useful when strength is needed.

A method for producing a phase-separable glass may be the same as a known method, except that raw materials are used so as to achieve the foregoing composition. Specifically, glass raw materials containing boron may be mixed and melted to prepare a phase-separable glass.

For example, raw materials containing constituent sources may be melted by heating and formed into a desired shape, as needed, thereby producing a phase-separable glass. The heating temperature at the time of melting by heating may be appropriately determined, depending on the raw material composition and so forth. The heating temperature can be usually in the range of 1350 to 1450 degrees (Celsius) and particularly 1380 to 1430 degrees (Celsius).

For example, sodium carbonate, boric acid, and silicon dioxide, which are used as the foregoing raw materials, are uniformly mixed. The mixture may be melted by heating to 1350 to 1450 degrees (Celsius). In this case, any of raw materials may be used as long as they contain an alkali metal oxide, boron oxide, and silicon oxide as described above.

In the case where a porous glass is formed into a predetermined shape, after the preparation of a phase-separable glass, the glass may be formed into any shape, for example, a tube, a plate, or a sphere, at about 1000 to about 1200 degrees (Celsius). For example, a method can be employed in which after the foregoing raw materials are melted to prepare a phase-separable glass, the temperature is decreased from the melting temperature to 1000 to 1200 degrees (Celsius), and the glass is formed into a shape with the temperature maintained thereat.

A phase-separated glass is typically prepared by subjecting a phase-separable glass to heat treatment.

The heat-treatment temperature for the phase separation may be appropriately set in the range of 400 to 800 degrees (Celsius), and the heat-treatment time may be appropriately set in the range of 10 to 100 hours, depending on, for example, the pore size of the resulting porous glass. Removal of portions to be pores from the phase-separated glass prepared by the heat treatment step provides a porous glass.

A method for removing the portions to be pores from the phase-separated glass typically includes bringing the phase-separated glass into contact with an aqueous solution to leach out a soluble phase.

A method for bringing a glass into contact with an aqueous solution typically includes immersing the glass in the aqueous solution. However, any method may be employed as long as the method includes bringing the glass into contact with the aqueous solution. For example, a method in which the aqueous solution is poured over the glass may be employed. As the aqueous solution, any of existing etching solutions, such as water, acid solutions, and alkaline solutions, which can leach out the soluble phase, may be used. A plurality of steps of bringing the glass into contact with the aqueous solution may be employed as needed.

In the case of a typical etching of a phase-separated glass, acid treatment can be used in view of low load on insoluble-phase portions and the degree of selective etching. Bringing the glass into contact with an acid solution leaches out an alkali metal oxide-boron oxide-rich phase, which is an acid-soluble component. Meanwhile, the degree of leaching of an insoluble phase is relatively small. It is thus possible to achieve high etching selectivity.

Examples of the acid solution that can be used include solutions of inorganic acids, such as hydrochloric acid and nitric acid. The acid solution can be typically used in the form of an aqueous solution whose solvent is water. Usually, the concentration of the acid solution may be appropriately set in the range of 0.1 to 2 mol/L (0.1 to 2 N).

In this acid-treatment step, the temperature of the solution may be set in the range of room temperature to 100 degrees (Celsius). The treatment time may be set in the range of about 1 to about 100 hours.

Note that an etching solution used to etch a phase-separated glass may not be an acid solution but may be water or an alkaline solution, as described above.

A process of etching a phase-separated glass body according to aspects of the present invention includes a step of bringing the phase-separated glass body into contact with a boron-containing solution having a boron concentration of 5 to 140 ppm.

The inventors have found that a phase-separated glass body is brought into contact with the boron-containing solution having a controlled boron concentration, so that the degree of etching can be achieved at a level that have not been achieved in the past.

Bringing a phase-separated glass body into contact with a solution containing boron that is a component contained in a soluble phase usually suppresses etching of the soluble phase containing a boron component. For example, in PTL 3, the addition of boron, which is a component contained in an insoluble phase, to an etching solution suppresses etching of the insoluble phase, thereby achieving selective etching. In fact, the inventors have conducted studies and have found that etching does not proceed at a high boron concentration as disclosed in PTL 3.

In aspects of the present invention, a phase-separated glass body is brought into contact with a boron-containing solution having a boron concentration of 5 to 140 ppm. It is thus possible to provide an effect that is not conceived from the related art.

A specific mechanism for the effect developed by contact with the boron-containing solution according to aspects of the present invention is not clear but is speculated as follows. In a soluble phase after phase separation, boron and silicon may be connected to form a network. In the etching process of the soluble phase, a boron component may be etched together with peripheral a silica component to which the boron component is bonded.

In the case of high leaching (diffusion) velocity of boron into the solution, however, boron may be leached into the etching solution without peripheral silica. That is, only the boron component is leached from the glass body. The remaining silicon component may form gel-like silica as described in NPL 2.

In aspects of the present invention, it is speculated that the leaching velocity of boron is controlled by the use of a boron-containing solution (etching solution) in which a certain amount of boron is contained in the solution, thereby promoting the leaching of silica to suppress the formation of the gel-like silica. Furthermore, the inventors have conducted studies and have found that with respect to the boron concentration, the initial concentration when the glass body is brought into contact with the etching solution is very important.

A large difference in boron concentration between the inside of the glass body and the solution results in a high leaching velocity of boron. Thus, it will be possible to achieve a higher effect by reducing the leaching velocity at that time.

In the production method according to aspects of the present invention, the phase-separated glass body can be brought into contact with the boron-containing solution having a boron concentration of 5 to 140 ppm, preferably 5 to 115 ppm, and more preferably 15 to 115 ppm. A boron concentration of less than 5 ppm fails to sufficiently provide the effect of adding boron. A boron concentration exceeding 140 ppm has a tendency of lead to the increase of the etching-inhibitory effect of the boron component, thus failing to promote etching. Examples of a boron source that can be used include boric acids, boric acid esters, borates, and borohydrides.

As a glass body used in aspects of the present invention, any structure including a phase-separated glass produced by subjecting a glass body containing boron to phase separation by heat treatment can be used.

The effects of aspects of the present invention can be provided in a structure entirely composed of a phase-separated glass, a structure partially composed of a phase-separated glass, and other structures. In the case of a structure partially composed of a phase-separated glass, the effects of aspects of the present invention can be provided by bringing a portion composed of the phase-separated glass into contact with the boron-containing solution.

Any aqueous solution prepared by any existing method can be used as long as the aqueous solution has a boron concentration within the range of aspects of the present invention. In particular, a boron-containing aqueous solution can be prepared by dissolving a boron source in an aqueous solution in view of the ease of controlling the boron concentration.

Non-limiting examples of the boron-containing aqueous solution according to aspects of the present invention include alkaline solutions and acidic solutions. The boron-containing aqueous solution has a pH of 4.0 to 10.0 and maximally 5.0 to 7.0.

In the boron-containing solution having the pH range described above, a low leaching velocity of a boron component into the solution facilitates the control of the leaching velocity of the boron component by the addition of a boron source. So, the effects of aspects of the present invention are more likely to be provided. A pH of less than 4.0 results in high leaching velocity of the boron component due to acidity, thus presumably causing difficulty in controlling the leaching velocity of the boron component by the addition of boric acid. A pH exceeding 10.0 results in high leaching velocity of the boron component due to alkalinity, thus presumably causing difficulty in controlling the leaching velocity of the boron component by the addition of boric acid.

Typically, after etching treatment (etching step 1) with an etching solution, for example, an acid solution or an alkaline solution, water treatment (etching step 2) can be performed.

The water treatment inhibits the adhesion of remaining components to the skeleton of the porous glass and has a tendency to lead to a porous glass having higher porosity. The temperature in the water treatment step may be typically set in the range of room temperature to 100 degrees (Celsius). The time in the water treatment step may be appropriately determined, depending on the composition, size, and so forth of a target glass. The time may be typically in the range of 1 to 50 hours.

The etching solution used in etching treatment may contain boron. Water used in water treatment may contain boron.

Aspects of the present invention can provide a greater effect by bringing a phase-separated glass body into contact with an etching solution and then a boron-containing solution.

Specifically, the boron concentration in water used in the water treatment step may be controlled. The reason for this is still not clear, but the inventors speculate that in the water treatment step, the boron concentration in the glass is reduced to a certain extent by the effect of etching step 1, so that the presence of boron in the aqueous solution facilitates the control of the leaching velocity.

In particular, a boron-containing aqueous solution used in the water treatment preferably has a pH of 4.0 to 10.0 and more preferably 5.0 to 7.0.

The boron-containing aqueous solution used in the water treatment preferably has a boron concentration of 5 to 115 ppm and more preferably 15 to 115 ppm.

Each of the etching solution used in etching step 1 and water used in etching step 2 can contain boron.

According to aspects of the present invention, one or more etching steps may be included, and the effects can be provided as long as the boron concentration in the solution falls within the range of aspects of the present invention.

A porous glass according to aspects of the present invention preferably has an average pore size of 1 nm to 900 nm, more preferably 2 nm to 500 nm, and still more preferably 10 nm to 100 nm, without limitation. The porous glass preferably has a porosity of 10% to 90% and particularly preferably 20% to 80%. A smaller average pore size has a tendency to cause difficulty in etching.

Examples of the shape of the porous glass include, but are not limited to, tubes, plates, films, and layer structures on substrates. These shapes may be appropriately selected, depending on the application of the porous glass.

The porous glass according to aspects of the present invention has a porous structure that can be widely controlled. So, the porous glass holds promise as an optical member, such as an optical lens for use in image pick-up systems, observation systems, projection systems, and scanning optical systems, and a polarizer for use in display apparatuses.

### EXAMPLES

While the present invention will be specifically described below by examples, the present invention is not limited to these examples.

### Method for Measuring Boron Concentration

Boron in a solution was measured as follows. A target solution was diluted 100 times with ultrapure water. The diluted sample was sprayed into an inductively coupled plasma with an inductively coupled plasma (ICP) spectrometer (trade name: CIROS CCD, manufactured by SPECTRO Analytical Instruments), and the emission intensity at 249.773 nm (boron) was measured. Comparison of the result with the emission intensity of a calibration standard having a known concentration determined the boron concentration (ppm) in the solution.

### Method for Measuring pH

The pH of a solution was measured as follows. Into a 50-mL glass vessel, 50-mL of a solution was charged. The pH of the solution was measured with a pH meter (Model: D-51, manufactured by HORIBA, Ltd.) at 24 degrees (Celsius) and a temperature during etching. In the case of measuring an acidic aqueous solution, the pH was lower than 0.0 (outside of the measurement range), in some cases. In that case, the pH was set to 0.0, for convenience.

### Production Example of Glass Body

A mixed powder of a quartz powder, boron oxide, sodium carbonate, and alumina were charged into a platinum crucible so as to have a feed composition of 64% by weight of SiO₂, 27% by weight of B₂O₃, 6% by weight of Na₂O, and 3% by weight of Al₂O₃. The mixed powder was melted at 1500 degrees (Celsius) for 24 hours.

After the temperature of the resulting glass was lowered to 1300 degrees (Celsius), the molten glass was poured into a graphite mold. The glass was left to cool in air for about 20 minutes and then held in a lehr set at 500 degrees (Celsius) for 5 hours. Finally, the glass was cooled over a period of 24 hours. The resulting borosilicate glass block was cut into plates each measuring 30 mm*30 mm*1.1 mm. Both surfaces of each plate were mirror-polished. The plates were allowed to stand in air for 2 weeks and subjected to phase separation by heat treatment in a muffle furnace at 560 degrees (Celsius) over a period of 25 hours. The phase-separated glass plates were cut into pieces each measuring 5 mm*5 mm*1.1 mm. Both surfaces of each piece were polished to provide glass body A.

### Production Example of Solution 1-1

An aqueous solution of nitric acid was prepared so as to have a concentration of 1.0 mol/L (1.0 N) and was defined as solution 1-1. This solution had a pH of 0.0 at 24 degrees (Celsius) and 0.0 at 80 degrees (Celsius). This solution had a boron concentration of 0 ppm.

### Production Example of Solution 1-2

The addition of 0.010 g of boric acid to 50 g of a 1.0 mol/L (1.0 N) aqueous solution of nitric acid resulted in solution 1-2. This solution had a pH of 0.0 at 24 degrees (Celsius) and 0.0 at 80 degrees (Celsius). This solution had a boron concentration of 35 ppm.

### Production Example of Solution 1-3

The addition of 0.030 g of boric acid to 50 g of a 1.0 mol/L (1.0 N) aqueous solution of nitric acid resulted in solution 1-3. This solution had a pH of 0.0 at 24 degrees (Celsius) and 0.0 at 80 degrees (Celsius). This solution had a boron concentration of 107 ppm.

### Production Example of Solution 1-4

The addition of 0.005 g of boric acid to 50 g of a 1.0 mol/L (1.0 N) aqueous solution of nitric acid resulted in solution 1-4. This solution had a pH of 0.0 at 24 degrees (Celsius) and 0.0 at 80 degrees (Celsius). This solution had a boron concentration of 14 ppm.

### Production Example of Solution 1-5

The addition of 0.035 g of boric acid to 50 g of a 1.0 mol/L (1.0 N) aqueous solution of nitric acid resulted in solution 1-5. This solution had a pH of 0.0 at 24 degrees (Celsius) and 0.0 at 80 degrees (Celsius). This solution had a boron concentration of 131 ppm.

### Production Example of Solution 1-6

The addition of 0.050 g of boric acid to 50 g of a 1.0 mol/L (1.0 N) aqueous solution of nitric acid resulted in solution 1-6. This solution had a pH of 0.0 at 24 degrees (Celsius) and 0.0 at 80 degrees (Celsius). This solution had a boron concentration of 179 ppm.

### Production Example of Solution 2-1

Deionized water was defined as solution 2-1. This solution had a pH of 6.7 at 24 degrees (Celsius) and 6.5 at 80 degrees (Celsius). This solution had a boron concentration of 0 ppm.

### Production Example of Solution 2-2

The addition of 0.010 g of boric acid to 50 g of deionized water resulted in solution 2-2. This solution had a pH of 6.6 at 24 degrees (Celsius) and 6.2 at 80 degrees (Celsius). This solution had a boron concentration of 28 ppm.

### Production Example of Solution 2-3

The addition of 0.030 g of boric acid to 50 g of deionized water resulted in solution 2-3. This solution had a pH of 6.1 at 24 degrees (Celsius) and 6.0 at 80 degrees (Celsius). This solution had a boron concentration of 102 ppm.

### Production Example of Solution 2-4

The addition of 0.005 g of boric acid to 50 g of deionized water resulted in solution 2-4. This solution had a pH of 6.7 at 24 degrees (Celsius) and 6.5 at 80 degrees (Celsius). This solution had a boron concentration of 11 ppm.

### Production Example of Solution 2-5

The addition of 0.035 g of boric acid to 50 g of deionized water resulted in solution 2-5. This solution had a pH of 6.1 at 24 degrees (Celsius) and 5.9 at 80 degrees (Celsius). This solution had a boron concentration of 128 ppm.

### Production Example of Solution 2-6

The addition of 0.040 g of boric acid to 50 g of deionized water resulted in solution 2-6. This solution had a pH of 6.1 at 24 degrees (Celsius) and 5.7 at 80 degrees (Celsius). This solution had a boron concentration of 143 ppm.

### Example 1

Glass body A was immersed in 50 g of solution 1-1 heated to 80 degrees (Celsius) and allowed to stand at 80 degrees (Celsius) for 24 hours (etching step 1). Subsequently, glass body A was immersed in 50 g of solution 2-2 heated to 80 degrees (Celsius) and allowed to stand at 80 degrees (Celsius) for 24 hours (etching step 2). The glass body was taken from the solution and dried at room temperature for 12 hours to provide glass body 1. The degree of etching in glass body 1 was evaluated.

### Measurement of Degree of Etching

A fracture surface of glass body 1 was observed with a scanning electron microscope (SEM) to evaluate the degree of etching from the surface. As the SEM, a field emission scanning electron microscope (trade name: S-4800, manufactured by Hitachi High-Technologies Corporation) was used. The observation was performed at an acceleration voltage of 5.0 kV and a magnification of 150,000.

FIG. 1 is an electron micrograph of a cross section of glass body 1 (porous glass) prepared in EXAMPLE 1 of the present invention. The results of the etching of glass body A in the cross-sectional direction demonstrated that glass body A included silica skeletons each having a size of about 30 nm and interconnected pores between the skeletons, the interconnected pores each having a size of about 30 nm.

The evaluation of the degree of etching of the glass can be made by observing a fracture surface of etched glass body 1. Specifically, observation is gradually performed from a surface of the glass toward the inside of the glass. A region extending from the surface to a portion including an interconnected pore which was located between skeletons and which had a size of about 5 nm or more was defined as an etched region.

Rank A: The etched region extends from the surface to a depth of 50 micrometers or more.

Rank B: The etched region extends from the surface to a depth of 41 micrometers to 49 micrometers.

Rank C: The etched region extends from the surface to a depth of 31 micrometers to 40 micrometers.

Rank D: The etched region extends from the surface to a depth of 30 micrometers or less.

Even when glass body 1 was a porous glass with nanosized pores each having a size of, for example, 30 nm, glass body 1 was etched from the surface to a depth of 70 micrometers. Table 1 shows the results of EXAMPLE 1.

### Examples 2 to 8

Glass bodies 2 to 8 were prepared as in EXAMPLE 1, except that solutions described in Table 1 were used in place of solution 1-1 in etching step 1 and that solutions described in Table 1 were used in place of solution 2-2 in etching step 2.

The resulting glass bodies were evaluated as in EXAMPLE 1. Table 1 shows the results.

Glass body 2 was etched from the surface to a depth of 52 micrometers. Each of the samples in EXAMPLES 2 to 8 exhibited a satisfactory degree of etching.

### Comparative Examples 1 to 3

Glass bodies 9 to 11 were prepared as in EXAMPLE 1, except that solutions described in Table 1 were used in place of solution 1-1 in etching step 1 and that solutions described in Table 1 were used in place of solution 2-2 in etching step 2.

The resulting glass bodies were evaluated. Table 1 shows the results.

Each of the samples in COMPARATIVE EXAMPLES 1 to 3 was etched from the surface to a depth of 30 micrometers or less and exhibited an insufficient degree of etching, compared with the samples in examples.

TABLE 1

| | | | | | | | | | | COMPAR- | COMPAR- | COMPAR- |
|---|---|---|---|---|---|---|---|---|---|---|---|---|
| | | | | | | | | | | ATIVE | ATIVE | ATIVE |
| | | EXAM- | EXAM- | EXAM- | EXAM- | EXAM- | EXAM- | EXAM- | EXAM- | EXAM- | EXAM- | EXAM- |
| | | PLE 1 | PLE 2 | PLE 3 | PLE 4 | PLE 5 | PLE 6 | PLE 7 | PLE 8 | PLE 1 | PLE 2 | PLE 3 |
| Etching | Solution | Solution | Solution | Solution | Solution | Solution | Solution | Solution | Solution | Solution | Solution | Solution |
| step 1 | | 1-1 | 1-1 | 1-1 | 1-1 | 1-2 | 1-3 | 1-4 | 1-5 | 1-1 | 1-1 | 1-6 |
| | Boron | 0 | 0 | 0 | 0 | 35 | 107 | 14 | 131 | 0 | 0 | 179 |
| | concentration | | | | | | | | | | | |
| | (ppm) | | | | | | | | | | | |
| | pH (24 degrees | 0.00 | 0.00 | 0.00 | 0.00 | 0.00 | 0.00 | 0.00 | 0.00 | 0.00 | 0.00 | 0.00 |
| | (Celsius)) | | | | | | | | | | | |
| | pH (80 degrees | 0.00 | 0.00 | 0.00 | 0.00 | 0.00 | 0.00 | 0.00 | 0.00 | 0.00 | 0.00 | 0.00 |
| | (Celsius)) | | | | | | | | | | | |
| Etching | Solution | Solution | Solution | Solution | Solution | Solution | Solution | Solution | Solution | Solution | Solution | Solution |
| step 2 | | 2-2 | 2-3 | 2-4 | 2-5 | 2-1 | 2-1 | 2-1 | 2-1 | 2-1 | 2-6 | 2-1 |
| | Boron | 28 | 102 | 11 | 130 | 0 | 0 | 0 | 0 | 0 | 143 | 0 |
| | concentration | | | | | | | | | | | |
| | (ppm) | | | | | | | | | | | |
| | pH (24 degrees | 6.59 | 6.09 | 6.70 | 6.10 | 6.67 | 6.70 | 6.73 | 6.76 | 6.70 | 6.09 | 6.70 |
| | (Celsius)) | | | | | | | | | | | |
| | pH (80 degrees | 6.24 | 5.96 | 6.30 | 5.90 | 6.47 | 6.47 | 6.47 | 6.47 | 6.47 | 5.66 | 6.46 |
| | (Celsius)) | | | | | | | | | | | |
| Glass body | | Glass | Glass | Glass | Glass | Glass | Glass | Glass | Glass | Glass | Glass | Glass |
| | | body 1 | body 2 | body 3 | body 4 | body 5 | body 6 | body 7 | body 8 | body 9 | body 10 | body 11 |
| Result | Degree of | A | A | B | C | B | B | C | C | D | D | D |
| | etching | | | | | | | | | | | |

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2010-220570, filed Sep. 30, 2010 and No. 2011-192812, filed Sep. 5, 2011, which are hereby incorporated by reference herein in their entirety.

### INDUSTRIAL APPLICABILITY

A porous glass produced by a production method according to aspects of the present invention can be used as a very useful member for use in the fields of, for example, adsorbents, microcarriers, separation membranes, and optical materials.

1. A method for producing a porous glass, comprising the steps of:
preparing a glass body containing boron;
subjecting the glass body to heat treatment for phase separation; and
bringing the phase-separated glass body into contact with a boron-containing solution having a boron initial concentration of 5 to 140 ppm.

2. The method for producing a porous glass according to claim 1, wherein the boron-containing solution has a pH of 4.0 to 10.0.

3. The method for producing a porous glass according to claim 2, wherein the boron-containing solution has a pH of 5.0 to 7.0.

4. The method for producing a porous glass according to claim 1, further comprising a step of:
bringing the phase-separated glass body into contact with an etching solution before the step of bringing the phase-separated glass body into contact with the boron-containing solution.

5. The method for producing a porous glass according to claim 1,
wherein the boron-containing solution contains water and boron.

6. The method for producing a porous glass according to claim 1, wherein the boron-containing solution has a boron initial concentration of 5 to 115 ppm.

7. The method for producing a porous glass according to claim 6, wherein the boron-containing solution has a boron initial concentration of 15 to 115 ppm.
